(19) United States
(12) Patent Application Publication
(10) Pub. No.: US 2008/0307606 A1
(43) Pub. Date: Dec. 18, 2008

(54) Hinge

(75) Inventor: Benny Karlsson, Eskilstuna (SE)

Correspondence Address: HOLLAND & HART, LLP, P.O BOX 8749, DENVER, CO, 80201, US

(73) Assignee: ASSA AB, ESKILSTUNA (SE)

(21) Appl. No.: 10/597,355

(22) PCT Filed: Feb. 9, 2005
(86) PCT No.: PCT/SE2005/000169

§ 371 Date: Sep. 3, 2008

(30) Foreign Application Priority Data
Feb. 9, 2004 (SE) 0400261-4

(51) Int. Cl. E05D 7/04

(52) U.S. Cl. 16/243; 16/242; 16/245

(57) ABSTRACT

A hinge (3, 3′) with a frame part (4, 204) and a door part (5), which door part exhibits a holding box (8, 8′) for installation on a door (1) or equivalent, and a hinge leaf (7, 207) that is detachably attachable to the box, which box comprises a lateral recess (19) for the hinge leaf, and a receiving part (20, 20′, 220) for the hinge leaf present inside the box. In order to permit the simple and reliable lateral adjustment of the door and its simple installation and removal and the positive fixing of the position of the hinge leaf in the receiving part, the box (8, 8′) is capable of being caused to move relative to the receiving part (20, 20′) by the actuation from the outside of an adjustment device (32) for the purpose of providing lateral adjustment of the box and the door in the plane of the door, perpendicular to the axis (A) of the hinge, and the hinge comprises a spring-actuated snap element (39, 239) for the detachable attachment of the position of the hinge leaf (7, 207) in the receiving part.

The present invention relates to a hinge with a holding box for accommodating a hinge leaf, and more specifically of the kind indicated in the preamble to claim 1.

Hinges of the indicated kind—which permit simple installation and removal can find application on different types of doors, windows, hatch covers and other hinged elements.

In order to permit adjustment of the hinged element in relation to the frame with its side pieces, lintel and sill, the hinge can be provided with means for adjustment in the vertical, closing and/or lateral direction.

In the case of a holding box of the kind in question, in particular for a door, the requirement is often imposed that it must be made of a fire-retardant material, so that the door remains in its closed position for as long as possible in the event of a fire.

In the case of other types of holding boxes for simpler purposes, one or more of the component parts of the holding box can consist of plastic, for example injection-molded plastic.

### PRIOR ART

Hinges which permit different types of adjustment between parts of the hinge are previously disclosed. For example, PCT/NO99/00153 (TrioVing) describes a hinge with a holding box which, in the first place, permits adjustment in the horizontal sense between parts of the hinge. This holding box has a complicated construction with a large number of constituent elements. According to one embodiment, the holding box also permits adjustment in the vertical sense. In practice, however, this involves a complicated operation, because both an upper and a lower adjusting screw must be actuated in conjunction with adjustment.

Another example of a complicated holding box which permits adjustment in the horizontal and vertical direction can be found in U.S. Pat. No. 5,339,493 (MacIntyre) This box has a considerable thickness and exhibits a centrally arranged horizontal screw element for longitudinal adjustment and also requires a substantially dimensioned recess in the door.

DE, C1, 44 31 799 describes a hinge with a frame part which comprises a holding box in which a receiving part receives the hinge leaf of the frame part. The hinge leaf is retained in the receiving part by means of a clamp joint comprising two locking screws and a locking washer. The receiving part is also retained in the holding box by a shaft journal and a rivet which extend through both the holding box and the receiving part and the hinge leaf. In order to separate the hinge leaf from the holding box and the receiving part, the holding box must accordingly first be removed from the frame. The shaft journal and the rivet must then be removed, the receiving part must be taken out of the holding box, and the clamped joint must be separated. Such removal and corresponding attachment of the hinge leaf requires the use of tools and is also complicated and time-consuming.

GB A 2 377 729 describes a hinge in which the door part leaf is directly accommodated in a door-mounted holding box. To permit adjustment of the door in the vertical, closing and lateral directions, the hinge comprises means to bring about relative movement between the holding box and the door part leaf. The holding box and the hinge leaf also comprise interacting snap-in devices for the attachment of the hinge leaf in the holding box. Because attachment by means of the snap-in devices is achieved between the two component parts that are capable of movement relative to one another, it is necessary for both of the interacting snap-in devices to exhibit corresponding free play between one another, which permits the relative movements. Such free play has a detrimental effect on the satisfactory attachment and fixing of the door part leaf to the holding box.

SE, C2, 516 251 and its international equivalent WO 01/B4261 describe a hinge with a receiving part, present in a holding box, for the accommodation and attachment of a hinge leaf by means of snap-in devices. This hinge exhibits means for achieving adjustment of the door in the vertical direction and in the closing direction, i.e. a direction that is perpendicular to both the axis of the hinge and the plane of the door. It is not possible with this hinge, however, to obtain any lateral adjustment of the door, perpendicular to the axis of the hinge and parallel to the plane of the door. Further examples of the prior art can be found in U.S. Pat. No. 5,806,144 (Fries), U.S. Pat. No. 5,788,351 (Prunty et al.) and U.S. Pat. No. 4,293,976 (Pittasch et al.).

Previously disclosed hinges thus do not offer both satisfactory and simple attachment and removal of the hinge leaf respectively to and from the holding box as a possibility for providing lateral adjustment of the door.

### OBJECT OF THE INVENTION

One object of the present invention is thus to make available a hinge which, at one and the same time, permits the simple and reliable lateral adjustment of a door attached to the hinge, in a direction perpendicular to the axis of the hinge and parallel to the plane of the door, and the simple attachment and removal of the door respectively to and from the door frame.

Another object is to make available a hinge of a kind with which the relative position between the parts that are capable of being separated from one another can be fixed to a satisfactory degree.

Yet another object is to make available a hinge of a kind which permits stepless lateral adjustment over a comparatively broad adjustment interval.

A further object is to make available such a hinge of simple construction, of which the holding box exhibits comparatively small installation dimensions, which hinge is executed as a mass-produced article with a small number of constituent parts and is reliable in use.

An additional object is to make available such a hinge with small installation dimensions, which permits both lateral adjustment and vertical adjustment of the door to be performed by the adjustment of only one part of the hinge.

A further object still is to make available such a hinge which permits simple and reliable adjustment both in the lateral sense and in the vertical sense by regulation of the position of the holding box relative to the receiving part present in the holding box.

### BRIEF DESCRIPTION OF THE INVENTION

These and other objects are satisfied by a hinge of the kind indicated in the first paragraph of this description, which hinge exhibits the distinctive features set out in the characterizing part of Claim 1.

In accordance with the invention, a very simple, compact and reliable construction is achieved in this way, which permits lateral adjustment of the door, i.e. adjustment of the position of the door along a line between both side pieces of the frame. A single adjustment device is required for the reliable lateral adjustment of the hinge parts, and it can be made simple to actuate from the outside of the box. The detachable attachment of the hinge leaf in the receiving part by the snap element also permits the simple removal and attachment of the door respectively from and to the frame. Because snap-in attachment is achieved between these two parts, which are motionless relative to one another when in the installed position, including during adjustment of the door, it is also possible for the snap-in attachment to be achieved without free play. The adjustment accuracy is increased, and the slack in the hinge is minimized in this way.

If the box and the receiving part are designed to achieve the lateral adjustment by means of a rotating movement relative to one another, a comparatively large lateral adjustment interval is made possible while retaining small installation dimensions for the box.

The lateral adjustment device can comprise a screw-nut combination, which permits simple adjustment with a conventional tool and which ensures that the relative position of the box and the receiving part is maintained after performing the adjustment.

A space-saving and reliable construction is achieved if the receiving part is mounted in such a way that it is capable of rotating in the box by means of projecting end journals.

By designing the receiving part with a channel to accept the hinge leaf that is defined by side walls that taper towards the ends of the channel, a larger angle of rotation is permitted between the box and the receiving part, in the limited movement space available inside the box.

By executing the box so that it is capable of movement relative to the receiving part, including in a direction that is parallel to the axis of the hinge, a solution is provided in which both lateral and vertical adjustment can be performed by regulation of one and the same hinge part and also by adjustment of the relative position between only two components in this hinge part.

A simple and reliable vertical adjustment is achieved by designing the vertical adjustment device as an eccentric element that is capable of rotating about a horizontal axis.

If the vertical adjustment device is instead designed as a threaded journal-nut combination, a simple and reliable construction is similarly achieved, which is also space-saving and means that the set vertical position is retained.

By designing the threaded journal in the vertical adjustment device so that it is capable of axial movement relative to the receiving part, the vertical position of the door can be set by first performing adjustment of one of several hinges arranged on the same door and only then adjusting the other hinges.

Further advantages and characteristics of the invention can be appreciated from the description of embodiments below and from the following patent Claims.

### BRIEF DESCRIPTION OF THE FIGURES

FIG. 1 is a section viewed from above of a door that is attached to a frame side piece by means of a hinge in accordance with a first embodiment of the invention. The door is shown in the closed position by a solid line and in the open position by a broken line.

FIG. 2 is a plan view of an unfolded hinge in accordance with the first embodiment.

FIG. 3 is an exploded view of the hinge shown in FIG. 2.

FIGS. 4-6 are sectioned views from above of the hinge shown in FIGS. 2 and 3, where this adopts different lateral adjustment positions. Also shown in the Figures is a part of a door that is attached to the hinge.

FIG. 7 is a perspective view of an unfolded hinge in accordance with another embodiment of the invention.

FIG. 8 is an exploded view of the hinge shown in FIG. 7.

FIGS. 9-11 are plan views of the hinge shown in FIGS. 7 and 8, with a part of the holding box removed, where the hinge adopts different vertical adjustment positions.

FIGS. 12 and 13 are exploded views respectively of the holding box and the frame part with a door part leaf of a hinge in accordance with a further embodiment of the invention.

### DETAILED DESCRIPTION OF MODES FOR CARRYING OUT THE INVENTION

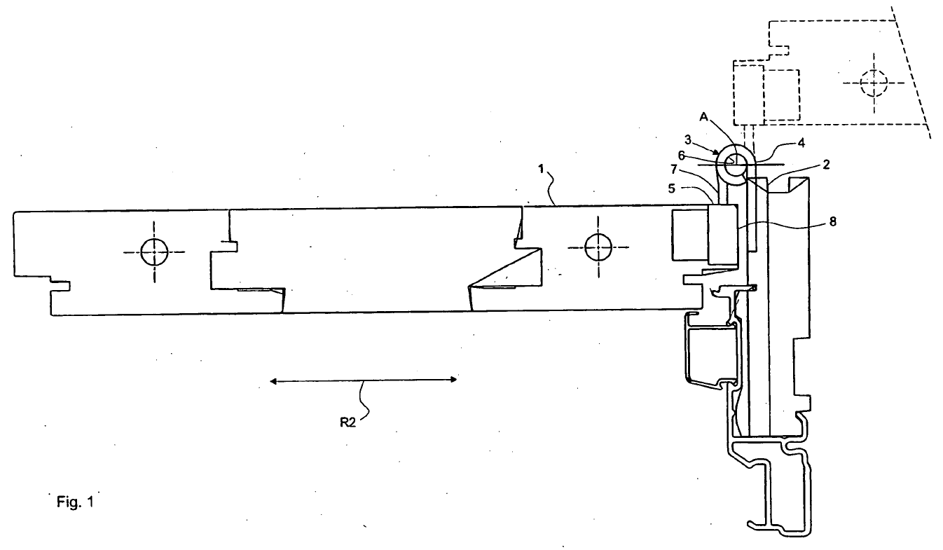

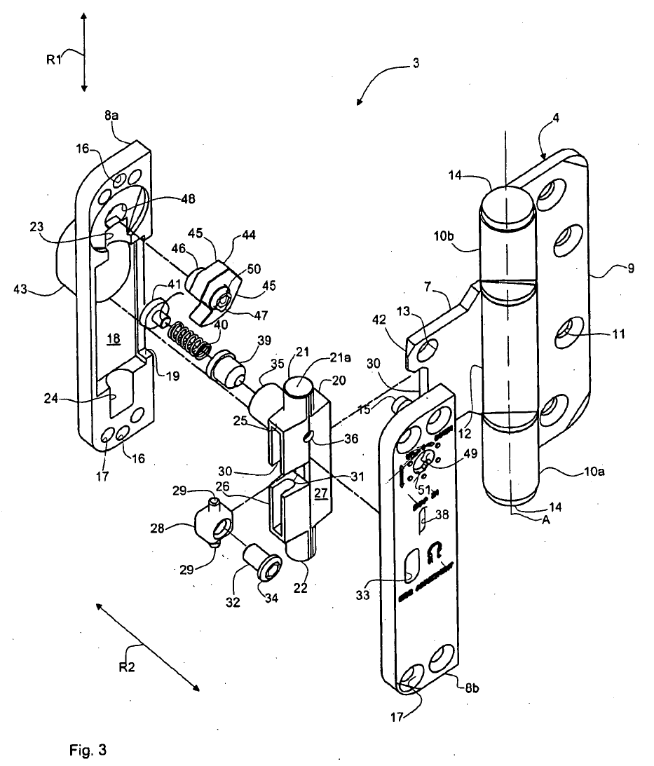

Illustrated in FIG. 1 is a door 1 that is attached to a frame 2 by means of a hinge 3 in accordance with the invention. In the Figure the door is shown in the closed position by an unbroken line and in the open position by a broken line. The hinge 3 comprises a frame part 4 and a door part 5, each of which exhibits a knuckle which surrounds a hinge pin 6 in the customary fashion. The central axis of the hinge pin 6, about which the door part 5 and thus the door 1 can pivot relative to the frame 2, defines a hinge axis A. The door part 5 also comprises a hinge leaf, namely a door part leaf 7 and a holding box 8, in which the door part leaf is accommodated and is snapped securely into engagement. The holding box 8 is attached in a previously disclosed fashion by means of screws to the door 1 in a recess provided for the purpose. The holding box 8 exhibits an opening 19 (FIG. 3) or a lateral recess for the introduction of the door part leaf 7. As can be appreciated from the Figure, the holding box 8 is oriented in relation to the door so that the opening 19 opens into the plane of the door.

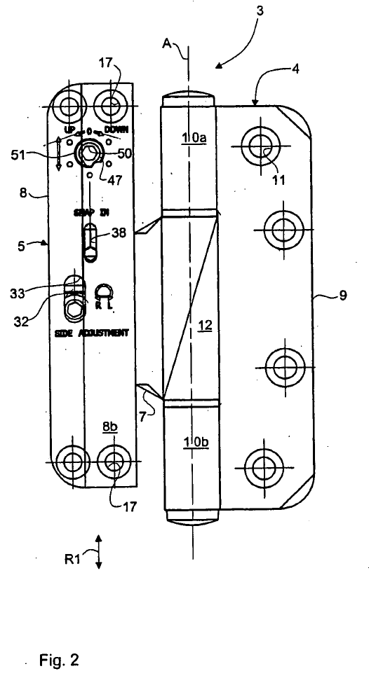

For adjustment of the door 1 relative to the frame 2, the hinge 3 exhibits means for adjusting the position of the door in two directions; R1 (see FIG. 2) and R2. One direction, R1, is parallel to the axis A of the hinge, and adjustment in this direction, in the illustrated example, thus involves an adjustment to the vertical position of the door. The other direction R2 is perpendicular to the axis A of the hinge and parallel to the principal plane of the door leaf. Adjustment in the direction R2, in the illustrated example, thus involves a lateral adjustment of the door. In the rest of the description, the expression vertical adjustment is used to denote adjustment in the direction R1, and lateral adjustment is used to denote adjustment in the direction R2. It will be appreciated, however, that adjustment along the directions R1 and R2 involves other movements relative to the horizontal plane if the hinge is installed so that the axis of the hinge is not vertical.

A first embodiment of the hinge 3 in accordance with the invention is described below with reference to FIGS. 2 and 3. The frame part 4, which comprises a frame part leaf 9 and two frame knuckles 10a, 10b, is illustrated in the Figures. The frame part leaf 9 exhibits a number of transcurrent holes 11 intended to accept screws (not shown) for attachment of the hinge 3 to the frame. The door part 5 of the hinge 3 comprises the door part leaf 7 and a door knuckle 12. A transcurrent snap hole 13 is accommodated at the end of the door part leaf 7 facing away from the door knuckle 12. The frame knuckles 10 and the door knuckles 12 enclose a central pin 6 (FIG. 1) and two outer pins, each with its own end cap 14. Both of the outer pins are fixed to the respective frame knuckle 10a, 10b.

The door part 5 also comprises a holding box 8, which exhibits two box halves 8a, 8b that are joined together. One box half 8b exhibits for this purpose two projecting male snap-in devices 15, which are snapped into engagement in corresponding female snap-in devices 16 in the other half of the box 8a. The two halves of the box 8a, 8b also exhibit transcurrent holes 17 intended to receive screws (not shown) for the attachment of the holding box 8 to the door. A chamber 18 is formed inside the box 8. The chamber 18 is open outwards on the long side of the box 8 facing towards the axis A of the hinge. The opening 19 in the box is formed by two opposing recesses 19a, which are accommodated in the two halves of the box 8a, 8b. The length of the recesses and thus the opening 19 in the box parallel to the axis A of the hinge is longer than the width of the door part leaf 7 in the same direction. The difference is such that the combined free play between the door part leaf 7 and the box opening 19, in a direction parallel to the axis A of the hinge, is equal to or greater than the distance over which the hinge is intended to permit vertical adjustment of the door.

A receiving part 20 is accommodated in the chamber 18 of the box 8. The receiving part 20 is pivotally mounted in the box 8 about an axis that is parallel to the axis A of the hinge. The receiving part 20 exhibits an upper 21 and a lower 22 journal for this purpose that are accommodated in such a way that they are capable of rotating in corresponding upper 23 and lower 24 bearing recesses in the two halves of the box 8a, 8b. The upper journal 21 exhibits an upper plane supporting surface 21a for an eccentric element 44 as described below. The distance between the end surfaces of the bearing recesses 23, 24 is greater than the distance between the end surfaces on the journals 21, 22 of the receiving part 20, in order to permit movement of the receiving part 20 parallel to the axis A of the hinge over a distance which corresponds to the vertical adjustment interval.

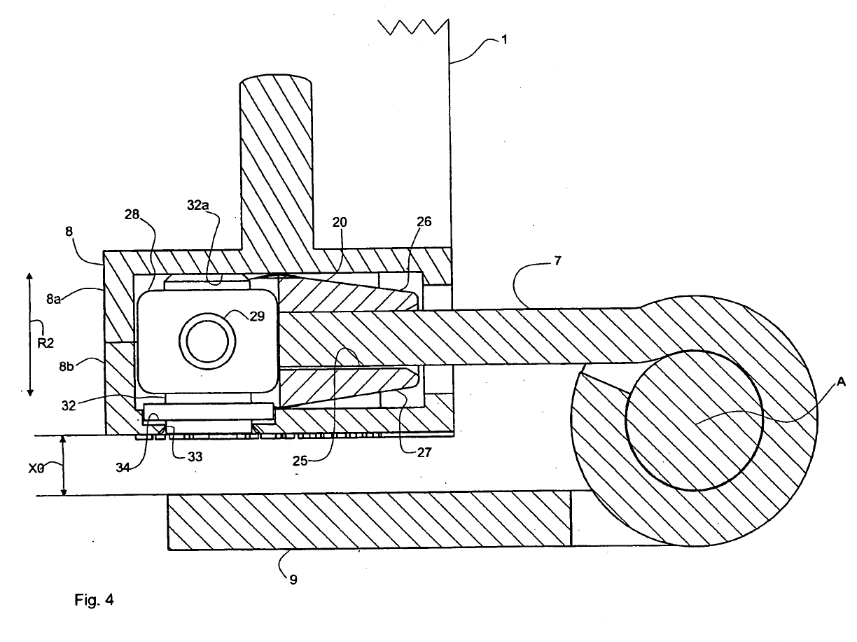

The receiving part 20 also exhibits a transcurrent channel 25, which accepts the door part leaf 7. The channel 25 is bounded laterally by side walls 26, 27 (see also FIGS. 4-6), and the dimensions of the cross section of the channel 25 essentially correspond to the width of the door part leaf, parallel to the axis A of the hinge, and its thickness. The cross section of the channel 25 is constant over the entire length of the channel, while the side walls 26, 27 are executed so that their outer surfaces converge in a direction outwards towards the mouths of the channel, from a thickest part of the receiving part 20. This thickest part is situated in line with the journals 21, 22 of the receiving part and its axis of rotation.

A nut part 28 in the form of an internally threaded sleeve with two opposing projecting engagement journals 29 is accommodated in a recess 30, which is accommodated in the two side walls 26, 27 at the end of the channel 25 facing away from the axis A of the hinge. The door part leaf 7 also exhibits a corresponding recess 37, which receives the nut part 28. The nut part 2E is fixed in a direction parallel to the axis A of the hinge by the vertical end surfaces of the recess 30 and by two bridges 31 which connect both of the side walls 26, 27, on a level with the vertical end surfaces of the recess 30. The two engagement journals 29 project into the channel 25 and are in engagement with the inner surfaces of the side walls 26, 27, respectively above and below the recess 30. An adjustment device in the form of a lateral adjustment screw 32 is threaded into the nut part 28. The screw 32 extends perpendicularly to the axis A of the hinge, and its movement in the axial sense is restricted by the insides of the chamber walls of the box halves 8a, 8b. In order to permit operation of the screw from the outside, one box half 8b exhibits a transcurrent operation hole 33 for the introduction of an Allen key. At its end facing towards the operation hole 33, the screw 32 exhibits an annular flange 34 which is supported against the wall of the box around the operation hole 33. The operation hole 33 has an extent in a direction parallel to the axis A of the hinge which corresponds to the vertical adjustment interval.

In order to provide detachable attachment of the door part leaf 7 in the receiving part 20, the latter exhibits a sleeve part 35 which projects laterally outwards from one side wall 26, directly in line with the snap hole 13 on the door part leaf 7. Accommodated in the sleeve part 35 are an axially mobile snap element in the form of a journal 39 and a spring 40, which is supported against a plug 41 driven into the mouth of the sleeve part, and which presses the journal 29 in a direction towards the channel 25. The inner space of the sleeve part 35 is attached to the channel 25 through a hole (not shown) in the side wall 26, which permits the journal 39 to project into the channel 25 and the snap hole 13 of the door part leaf 7.

A snap operation hole 36 is accommodated in the other side wall 27, directly in line with the hole between the sleeve 35 and the channel 25. The box half 8b is also provided with a corresponding snap operation hole 38, which permits the introduction of a long and narrow snap operation tool, for example a screwdriver, into the snap operation hole 36 on the side wall 27 and the snap hole 13 on the door part leaf 7. The snap operation hole 38 of the box half 8b has an extent in a direction parallel to the axis A of the hinge which corresponds to the vertical adjustment interval.

The box half 8a exhibits an outer hollow sleeve part 43, which receives the sleeve part 35 of the receiving part 20. The internal dimensions of the outer the sleeve part 43 are such that the sleeve part 35 of the receiving part 20 is free to move in the outer sleeve part 43 when the receiving part 20 moves relative to the holding box 8 during vertical and lateral adjustment of the hinge 3.

When the door 1 with a holding box 5 mounted thereon shall be mounted on the door part leaf 7 attached to the frame 2 by means of the frame part 4, the free end of the door part leaf 7 is introduced into the box opening 19 and onwards into the channel 25 of the receiving part 20. A sharp-pointed part 42 of the free end of the door part leaf 7 presses the journal 39 into the sleeve part 35 against the effect of the spring 40.

When the door part leaf 7 is fully inserted, the snap hole 13 in the door part leaf 7 is situated directly in line with the hole between the channel 25 and the sleeve part, in conjunction with which the journal snaps into the snap hole 13 under the effect of the spring 40 and fixes the position of the door part leaf in the receiving part 20. When the door 1 is to be removed, it is possible to introduce a screwdriver or similar tool through the respective snap operation hole 38, 36 of the holding box 8 and the receiving part 20 in order to press the journal 39 into the sleeve part 35 and, by so doing, to release the engagement of the journal 39 with the snap hole 13.

The holding box 8 also contains a vertical adjustment device in the form of an eccentric element 44. The eccentric element 44 exhibits a number of eccentrically arranged plane body segments 45 and two opposing bearing journals 46, 47 projecting in an axial direction. The bearing journals 46, 47 are rotatably mounted about a horizontal axis in the bearing seats 48, 49, which are accommodated in the two halves of the box 8a, 8b. The bearing journal 47 mounted in the box half 8b exhibits a hexagonal socket 50 accommodated at the end for the purpose of rotating actuation from outside by means of an Allen key. The bearing journal 47 extends for this purpose in a transcurrent vertical operation hole 51, which is accommodated in the box half 8b concentrically with the bearing recess 49.

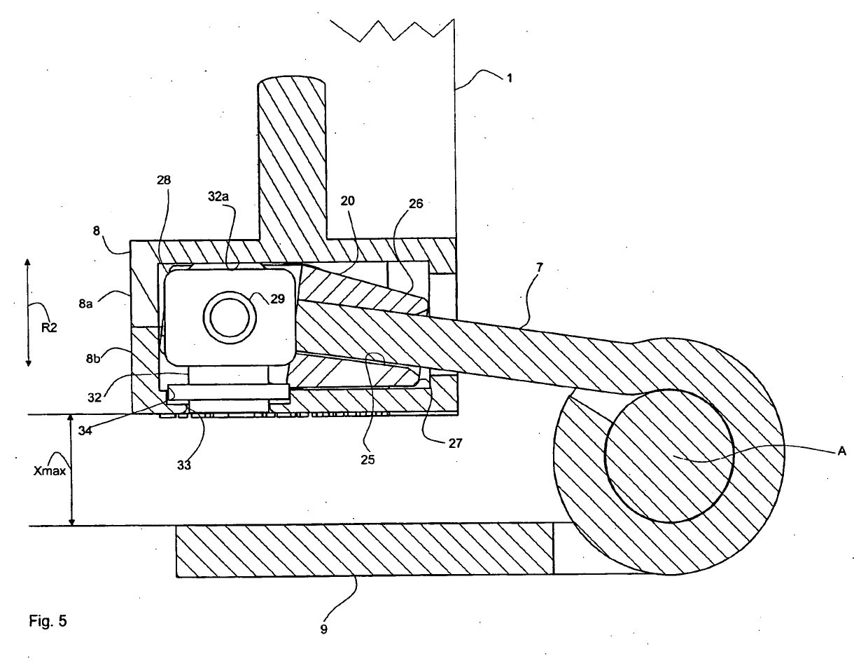

With reference to FIGS. 4-6, described below is the lateral adjustment in the direction R2 of the hinge 3 described above, which is parallel to the principal plane of the of the door leaf and perpendicular to the axis A of the hinge. The hinge is illustrated in FIG. 4 when it is set in a central position, which is represented in the Figure by the distance X₀ between the frame part leaf 9 and the holding box 8 when the hinge 3 is in a position which corresponds to a closed door, i.e. the position illustrated in FIG. 1 by unbroken lines. The angle between the plane of the door and the door part leaf 7 of the hinge in this position is 90°. It is now possible from this central position X₀ to change the lateral adjustment of the door, so that the box and the door in the closed position adopt the position Xₘₐₓ illustrated in FIG. 5 relative to the frame part leaf 9.

Such lateral adjustment to provide maximum free play between the door and the hinge side of the door frame is performed by first opening the door. The right-hand-threaded lateral adjustment screw 32 is then caused to rotate, by means of an Allen key, in a counterclockwise direction. The screw 32 is prevented from moving in an axial direction relative to the box 8 by the contact of the screw tip 32a with the inner chamber wall of the half 8a of the box and the contact by the annular flange 34 with the inner wall of the half 8b of the box around the operation hole 33. In order to prevent the screw from binding, however, a small amount of axial play can be arranged between the screw and the two halves 8a, 8b of the box. The receiving part is 20 is fixed to the door part leaf 7, and the engagement of the engagement journals 29 of the nut part 28 with the inside of the side walls 26, 27 of the channel 25 is such that the nut part is only permitted to rotate about the axis passing through the engagement journals 29, relative to the receiving part 20. During counterclockwise rotation of the adjustment screw 33, the screw 33 is unscrewed from the nut element 28, in conjunction with which the flange 34 of the screw 33 is displaced in a direction away from the nut element 28. The flange 34 in this case, through contact with the inner wall of the half 8b of the box around the lateral operation hole 33, causes the holding box 8 to rotate counterclockwise about the axis of rotation through the upper 21 and lower 22 journals of the receiving part 20. In this way, the door will also be caused to rotate counterclockwise relative to the door part leaf 7, so that the angle between them is greater than 90°. When the door 1 is closed again, this larger angle between the door 1 and door part leaf 7 means that the door will come into contact with/stop against the closing surface of the frame before the door part leaf 7 has completed its rotation in the direction of closing around the axis A of the hinge to the previously closed position when the door part leaf 7 was parallel to the frame part leaf 9. The door part leaf 7 and the frame part leaf 9 thus form an acute angle in the new closed position, after lateral adjustment has been completed, which means that the holding box 8 and the door 1 are situated at a distance Xₘₐₓ from the frame part leaf 9 that is greater than X₀. The door 1 has thus been subjected to a lateral adjustment in a direction from the frame side piece to which the hinge is attached.

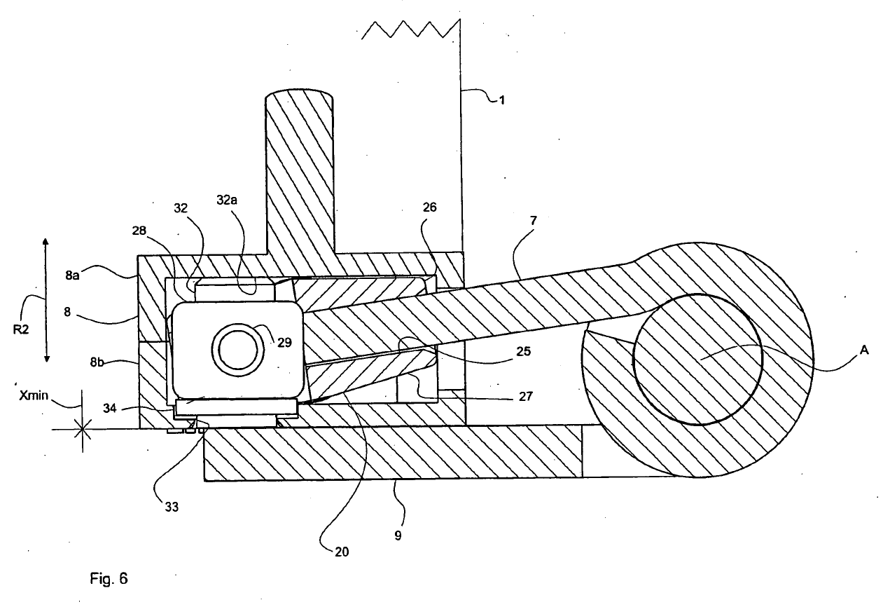

Illustrated in FIG. 6 is a lateral adjustment position Xₘᵢₙ for the holding box 8 and the door, in which the free play between the box 8 and the frame part leaf 9 is minimal. The adjustment screw 32 in this case, when the door is in the open position, has been rotated in a clockwise direction until the screw 32 is fully screwed into the nut part 28. The tip 32a of the screw has then been pressed against the inside of the half 8a of the box and has thus caused the box 8 to rotate in a clockwise direction relative to the receiving part 20 so that the door 1 also rotates in a clockwise direction relative to the door part leaf 9. In this way the angle between the plane of the door and the door part leaf 9 is less than 90°, so that, when the door closes once more, the door part leaf 7 can be caused to rotate about the axis A of the hinge to a position in which the door part leaf has progressed beyond parallelism with the frame part leaf 9 before the door 1 closes against the frame. The holding box 8 and the door 1 have then adopted a new lateral adjustment position, in which the distance Xₘᵢₙ between the box 8 and the frame part leaf 9 is less than Xₘₐₓ and X₀.

In the exemplifying embodiment of a hinge in accordance with the invention described above, lateral adjustment of the door is permitted by ±4 mm from the central position X₀. It will be appreciated that adjustment can be achieved steplessly to any value within the interval.

Once again with reference to FIG. 3, vertical adjustment of the door in the direction R1 for the embodiment of the invention described above is described below. Vertical adjustment of the door is performed when the door is in the open position. An Allen key is introduced into the hexagonal socket 50 in the bearing journal 47 of the eccentric element 44, after which the eccentric, element 44 is caused to rotate about its horizontal axis of rotation through both of the bearing journals 46, 47. Counterclockwise rotation of the eccentric element 44 causes the plane body segments 45 at a successively increasing distance from the axis of rotation of the eccentric element 44 to come into supporting contact with the upper horizontal supporting surface 21a of the upper journal 21 of the receiving part 20. The receiving part 20 and its supporting surface 21a are fixed in the vertical sense relative to the door part leaf 7 and thus to the frame. The eccentric element 44 remains essentially motionless in the vertical sense relative to the box 8 through the mounting of the bearing journals 46, 47 in the bearing seats 48, 49 of the holding box 8. A certain small degree of radial free play between the bearing journals 46, 47 and the bearing seats 48, 49 can be permitted, however, in order to counteract friction during the rotational movement. The holding box 8 is movable in the vertical direction relative to the receiving part 20, as described above. When the plane body segments 45 situated at a successively increasing distance from the axis of the eccentric element 44 come into contact with the supporting surface 21a, the axis of the eccentric element 44 and thus the holding box and the door will thus be displaced upwards successively relative to the supporting surface 21a and thus to the frame. The vertical adjustment of the door 1 relative to the frame is adjusted upwards in this way. The door is lowered relative to the frame in a corresponding fashion when the eccentric element 44 is caused to rotate in a clockwise direction and the effect of gravity on the door causes plane body segments 45 at a successively reducing distance from the axis of the eccentric element 44 to come into contact with the supporting surface 21a.

In accordance with an embodiment that is not shown here, the eccentric element can exhibit a curved body surface with a continuously increasing distance from the axis, instead of a number of plane body segments. Such an embodiment permits stepless vertical adjustment, but at the same time exhibits the disadvantage that the eccentric element must be locked after performing vertical adjustment in order to prevent the effect of gravity from returning the door to the lowest adjustment position. In the embodiment with a number of plane body segments 45, which make contact with the plane supporting surface 21a, no such extra locking is required because the plane contact in itself prevents the effect of gravity from returning the door to the lowest position.

In the embodiment illustrated in FIG. 3, vertical adjustment of the door is permitted within the interval from −3.0 mm to +4.5 mm from a neutral position.

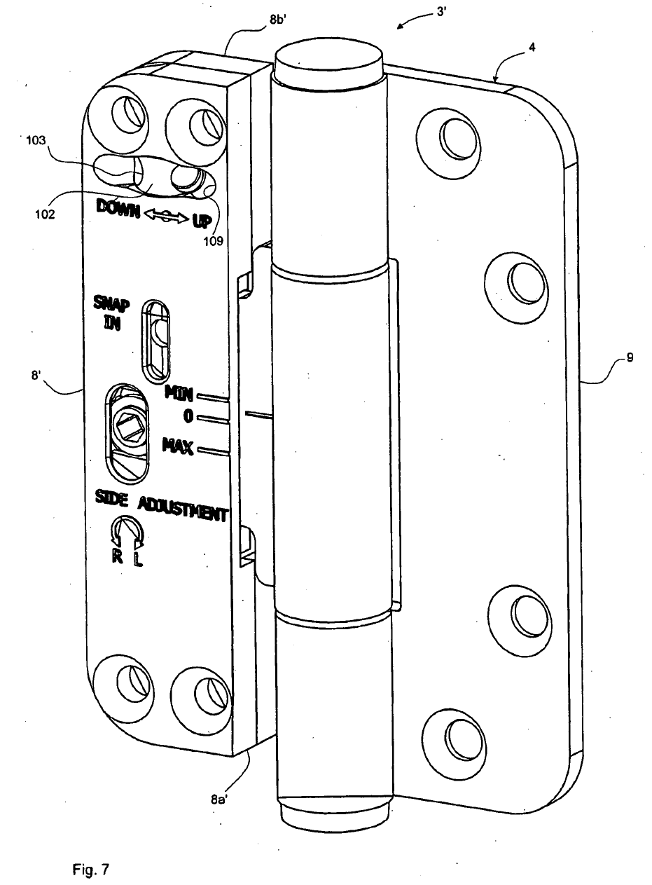

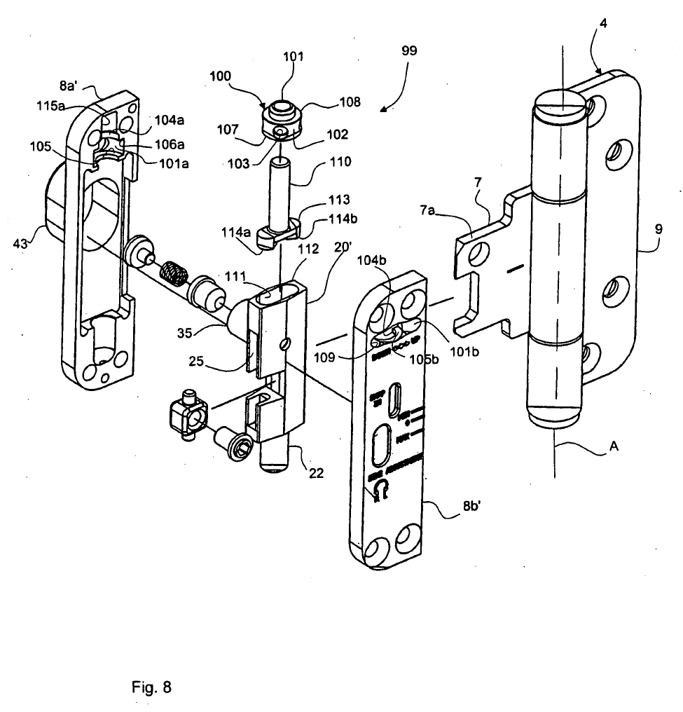

A further embodiment of the hinge 3′ in accordance with the invention is described below with reference to FIGS. 7 and 8. This embodiment corresponds fully to the embodiment shown in FIGS. 2 to 6 as far as concerns the frame part 4, the door part leaf 7, its snap-in attachment to the receiving part 20′ and the means for achieving lateral adjustment of the door. The features which distinguish this embodiment from those described above are described below.

The embodiment shown in FIG. 8 comprises a vertical adjustment device 99 comprising a nut element 100. The nut element 100 comprises an upper cylindrical bearing part 101 and a lower cylindrical operating part 102 with a greater diameter than the bearing part 101. A number of radial operation holes 103 are present in the operating part 102 in order to permit operation of the nut element 100 from the outside, by means of a sharp-pointed tool. The nut element 100 is rotatably mounted in bearing recesses 101a, 101b in the respective half 8a′ 8b′ of the holding box 8′. The bearing recesses 101a, 101b respectively exhibit semi-circular bearing surfaces 104a, 104b for pivot bearing interaction with the body surface of the bearing part 101. The bearing recesses 101a, 101b also exhibits lower 105a, 105b and upper 106a horizontal bearing surfaces (the upper bearing surface arranged in the box half 8b′ is not visible in FIG. 8). The lower bearing surfaces 105a, 105b interact with a corresponding lower bearing surface 107, and the upper bearing surfaces 106a interact with an upper horizontal bearing surface 108 on the operating part 102 of the nut element 100 in order to prevent relative axial movement between the nut element 100 and the holding box 8′ and to transmit vertical forces between them. A certain small degree of axial free play between the nut element 100 and the bearing recesses 101a and 101b can be permitted, however. A transcurrent hole 109 is also present in the box half 8b′ in order to permit the introduction of the sharp-pointed operation tool into the radial operation holes 103 in the nut element 100, from outside the holding box 8′.

The vertical adjustment device 99 also comprises a threaded journal 110 which, in the event of the lateral adjustment of the hinge, corresponds to the upper journal 21 of the receiving part 20, in the embodiment shown in FIGS. 2-6. The threaded journal 110 is screwed into the nut element 100 and is axially mobile relative to the receiving part 21′, parallel to the axis A of the hinge. The receiving part 20′ exhibits a journal channel 111 for this purpose, which extends along the axis of rotation of the receiving part 20′ from an upper end surface 112, and which opens into the channel 25. The threaded journal 110 comprises at its lower end a flange 113 which exhibits essentially the same cross-sectional geometry as the journal channel 111, in order to prevent rotation of the threaded journal 110 relative to the receiving part 20′. The flange 113 exhibits two downward-projecting support heels 114a, 114b, which, when the threaded journal is in its lowest position relative to the receiving part 20′, are supported against the upper surface 7a of the door part leaf 7 to either side of a bridge (not shown), which is arranged in the journal channel 111, at its opening into the channel 25 of the receiving part 20′. In order to permit vertical movement of the holding box 6′ relative to the threaded journal 110, a journal recess 115a is accommodated in the respective half 8a′, 8b′ of the box above the bearing recesses 101a, 101b (the journal recess arranged in the half 8b of the box is not visible in the Figures).

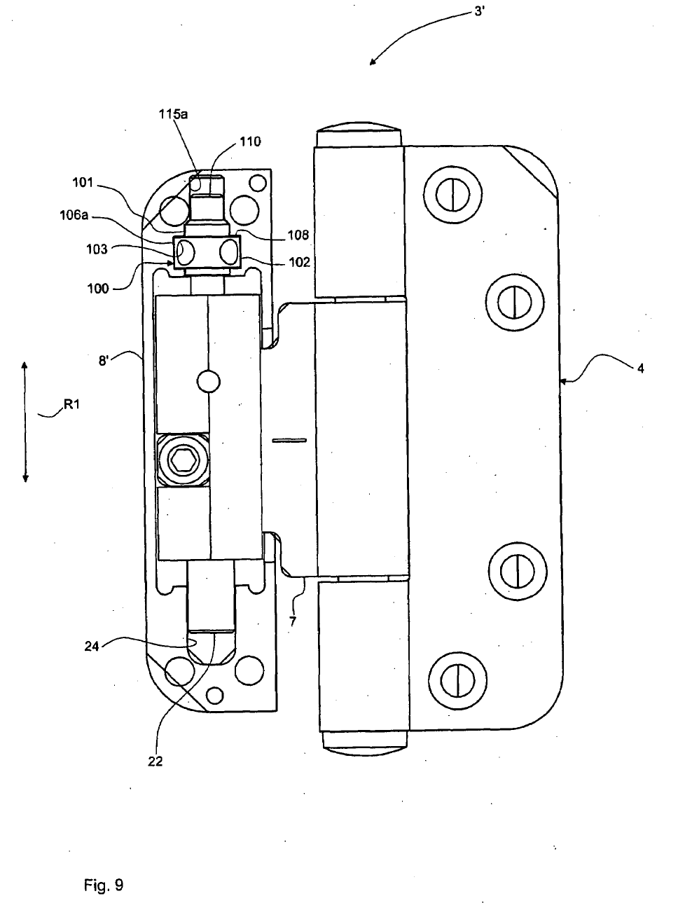

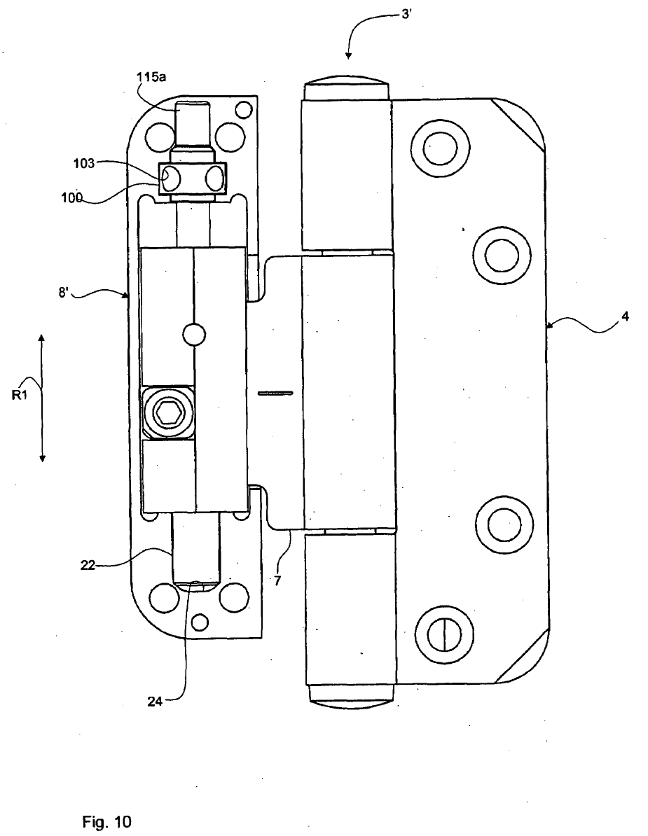

With reference to FIGS. 9-11, vertical adjustment in a direction R1 of the hinge in accordance with the embodiment shown in FIGS. 7 and 8 is described below. The hinge 3′ is illustrated in FIG. 9 when the holding box 8′ is in a vertical central position relative to the frame part 4. Starting from this central position, it is possible to raise the position of the holding box 8′ relative to the door part leaf 7 and thereby to lift the door attached to the holding box 8′ (not shown) This is done by introducing a sharp-pointed tool through the hole 109 in the half 8b of the box (see FIG. 7) and into one of the operation holes 103 in the nut element 100, and by then repeatedly rotating the right-hand-threaded nut element 100 to the right in the Figure. The nut element 100 is then displaced through threaded interaction with the threaded journal 110, which, with its support heels 114a, 114b (FIG. 8), is supported against the upper edge 7a of the door part leaf 7, along the journal 110 in a direction upwards. In conjunction with this upward displacement, the upper bearing surface 108 of the nut element 100 makes contact with the upper bearing surfaces 106a of the bearing recesses 101a, 101b, in conjunction with which the holding box 8′ and with it the door are accordingly displaced upwards to the upper position shown in FIG. 10. As in the embodiment shown in FIG. 3, the length of the lower bearing space 24 of the holding box 8′ permits the holding box 8′ to be displaced upwards without the lower journal 22 of the receiving part 20′ striking the bottom of the bearing space 24.

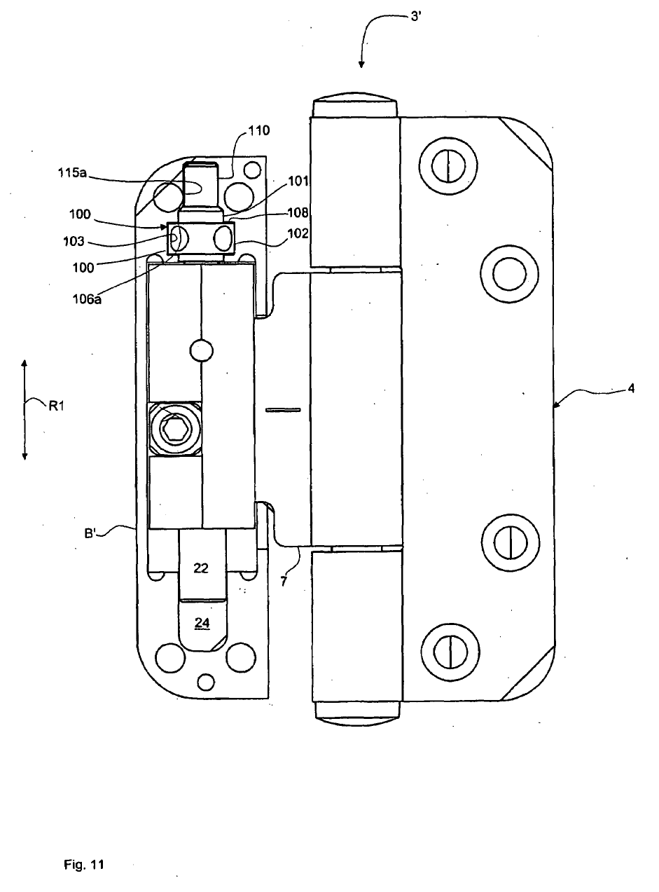

In order to lower the door to the position shown in FIG. 11, the nut element 100 is instead rotated to the left in the Figure, in conjunction with which the nut element 100 is displaced downwards along the threaded journal 110, so that the holding box 8′ and the door are lowered under the effect of gravity, which holds the supporting heels 114a, 114b in contact with the door part leaf 7. During this downward-directed movement of the holding box 8′, the journal recesses 115a permit the box 8′ to move downwards around the upper part of the threaded journal 110.

Stepless vertical adjustment of the door is thus permitted with the embodiment shown in FIGS. 7-10. For as long as the thread angle of the nut element 100 and the threaded journal 110 are not too great, no separate locking of the nut element 100 will be required in the set position. Given that the threaded journal is capable of axial movement relative to the receiving part 20′, the construction also permits a door with, for example, two hinges arranged one above the another to be adjusted in the vertical sense by first adjusting the upper hinge, for example, and then the lower hinge. During upward adjustment of the holding box of the upper hinge, the threaded journal in the lower hinge will accompany the movement of the door upwards. Once adjustment of the upper hinge is complete, the nut element in the lower hinge is rotated to the right, so that the threaded journal moves downwards until its support heels 114a, 114b come into contact with the door part leaf of the lower hinge.

The embodiment illustrated in FIG. 7-10 permits vertical adjustment of the door in the interval from −3.2 mm to +4.8 mm starting from a neutral position.

In an alternative embodiment, not shown here, the threaded journal can be fixed to the receiving part. Such an embodiment permits the holding box and with it the door to be displaced in both axial directions of the threaded journal even without the effect of gravity on the door and the holding box, for example by the installation of the hinge so that the axis A of the hinge and thus the direction of adjustment R1 are horizontal.

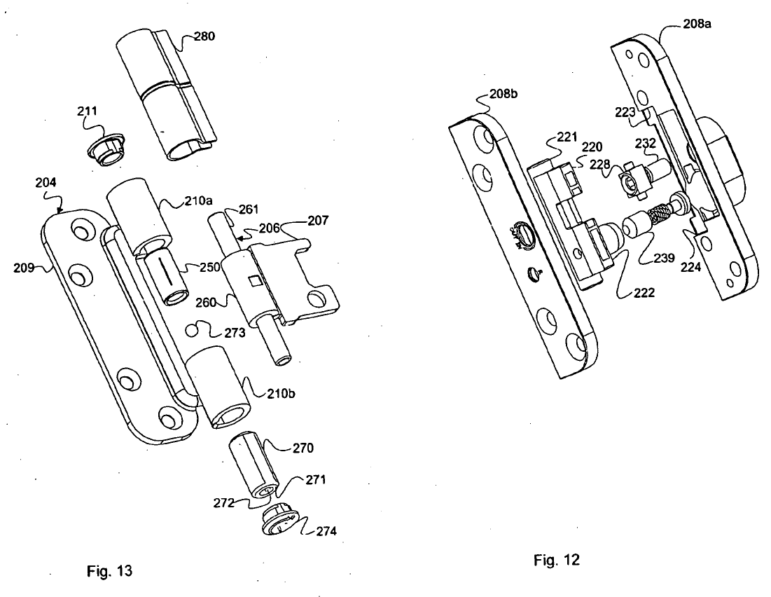

With reference to FIGS. 12 and 13, a further embodiment of the hinge in accordance with the invention is described below. The holding box illustrated in FIG. 12 comprises two box halves 208a, 208b. A receiving part 220 is accommodated in the holding box. As in the previously described embodiments, a spring-loaded snap-in element 239 for the attachment of the door part leaf 207 in the receiving part 220 and a nut part 228 with a lateral adjustment screw 232 for the lateral adjustment of the door are arranged in the holding box. The receiving part 220 also exhibits an upper 221 and a lower 222 journal that are rotatably accommodated ill corresponding upper 223 and lower bearing recesses in the two halves of the box 208a, 208b. Unlike the embodiments illustrated in FIGS. 3 and 8, the distance between the end surfaces of the journals 221, 222 essentially corresponds to the distance between the end surfaces of the bearing recesses 223, 224, so that the receiving part 220 and the holding box are unable to move to a significant degree in the axial sense relative to one another.

The frame part 204 of the hinge comprises a frame part leaf 209 and two frame knuckles 210a, 210b. An upper cylindrical bearing sleeve 250 is accommodated in the upper frame knuckle 210a, the upper end of which is closed by an upper end plug 211. The lower frame knuckle 210b exhibits internal threads, and a vertical adjustment sleeve 270 with corresponding external threads is screwed into the lower frame knuckle 210b. The vertical adjustment sleeve 270 exhibits an inner cylindrical space, which is open towards the top but is closed towards the bottom by an end wall 271. A hexagonal socket 272 accessible from the outside is arranged in the end wall 271, so that an Allen key can be used to regulate the axial position of the sleeve relative to the lower frame knuckle 210b by screwing the vertical adjustment sleeve 270 into and out of the lower frame knuckle 210b. A bearing ball 273 is also accommodated in the inner cylindrical space of the vertical adjustment sleeve 270 and makes contact there against the inside of the end wall 271. The lower end of the lower frame knuckle 210b is closed by an end plug 274.

The door part leaf 207 is fixed to a hinge pin 206 by means of a connection 260 enclosing the hinge pin 206. The hinge pin 206 exhibits an upper end 261 and a lower end 262 projecting axially from the connection 260. The end surface 262a of the lower end 262 is concave with a spherical form which corresponds to the form of the bearing ball 273. The upper end 261 of the hinge pin 206 is accommodated in the upper bearing sleeve 250 in such a way as to be capable of rotational and axial displacement. The lower end 262 of the hinge pin 206 is rotatably accommodated in the vertical adjustment sleeve 270, in conjunction with which the end surface 262a is supported by the end wall 271 of the vertical adjustment sleeve 270 and the interjacent bearing ball 273. A covering sleeve 280 is arranged between the upper 210a and lower 210b frame knuckle, around the hinge pin 206 and the connection 260. The axial length of the connection in relation to the distance between the ends of the two frame knuckles 210a, 210b which face one another is such that the hinge pin 206 and the door part leaf 207 are permitted significant axial movement in relation to the frame part 204 of the hinge.

It will be appreciated that vertical adjustment of a door attached to the holding box 208 is achieved simply by first removing the end plug 274 of the lower frame knuckle 210b and by then adjusting the position of the sleeve 270 and thus the hinge pin 206 supported therein, and of the door part leaf 207 in relation to the frame part 204 attached to the frame, by the clockwise or counterclockwise rotation of the vertical adjustment sleeve 270 using an Allen key.

The embodiment of the invention illustrated in FIGS. 12 and 13 among other things exhibits the advantage that the installation dimensions of the holding box are independent of the desired vertical adjustment interval. In this embodiment in particular, the dimensions of the holding box can be further reduced at the same time as the vertical adjustment interval can be increased. At the same time, this embodiment permits the same positive attachment by the snap-in engagement of the door part leaf in the receiving part and the same simple and accurate lateral adjustment as in the embodiments described above.

In the embodiments described above, the hinge leaf, the knuckles and the hinge pins are executed in steel, the holding box in zinc and the receiving part in one or other comparatively high-strength metallic material. It is also possible in certain applications, however, to manufacture the constituent components from other materials, for example polymer materials.

As indicated in the Figures, the outside of the holding box can be provided with, for example, impressed, engraved or cast-in adjustment markings and instructions in the vicinity of the respective adjustment/operation opening through the wall of the holding box, in order to facilitate the adjustment operation.

The invention is naturally not restricted to the embodiments described above, but can be varied within the scope of the following patent Claims.

knuckle 210b and by then adjusting the position of the sleeve 270 and thus the hinge pin 206 supported therein, and of the door part leaf 207 in relation to the frame part 204 attached to the frame, by the clockwise or counterclockwise rotation of the vertical adjustment sleeve 270 using an Allen key.

The embodiment of the invention illustrated in FIGS. 12 and 13 among other things exhibits the advantage that the installation dimensions of the holding box are independent of the desired vertical adjustment interval. In this embodiment in particular, the dimensions of the holding box can be further reduced at the same time as the vertical adjustment interval can be increased. At the same time, this embodiment permits the same positive attachment by the snap-in engagement of the door part leaf in the receiving part and the same simple and accurate lateral adjustment as in the embodiments described above.

In the embodiments described above, the hinge leaf, the knuckles and the hinge pins are executed in steel, the holding box in zinc and the receiving part in one or other comparatively high-strength metallic material. It is also possible in certain applications, however, to manufacture the constituent components from other materials, for example polymer materials.

As indicated in the Figures, the outside of the holding box can be provided with, for example, impressed, engraved or cast-in adjustment markings and instructions in the vicinity of the respective adjustment/operation opening through the wall of the holding box, in order to facilitate the adjustment operation.

The invention is naturally not restricted to the embodiments described above, but can be varied within the scope of the following patent Claims.

1. A hinge (3, 3′) with a frame part (4, 204) and a door part (5), which door part exhibits a holding box (8, 8′) for installation on a door (1) or equivalent and a hinge leaf (7, 207) capable of detachable attachment to the box, which box comprises a lateral recess (19) for the hinge leaf, and present in the box a receiving part (20, 20′, 220) for the hinge leaf, characterized in that the box (8, 8′) is capable of movement relative to the receiving part (20, 20′, 220) through the external influence of an adjustment device (32, 232) in order to produce lateral adjustment of the box and the door in the plane of the door, perpendicular to the axis (A) of the hinge and in a spring-actuated snap element (39, 239) for the detachable attachment of the position of the hinge leaf (7, 207) in the receiving part.

2. A hinge as claimed in claim 1, in which the box (8, 8′) and the receiving part (20, 20′, 220) are designed in such a way, as to execute a rotating movement relative to one another about an axis parallel to the axis (A) of the hinge through actuation of the adjustment device (32, 232).

3. A hinge as claimed in claim 2, in which the adjustment device exhibits a screw (32) that is axially locked relative to the box (8, 8′) and interacts with a nut part (28, 228), which, as the screw is rotated, produces the relative rotating movement by engagement with the receiving part (20, 20′, 220).

4. A hinge as claimed in claim 2, in which the receiving part (20, 20′, 220) exhibits projecting end journals (21, 22, 110) that are mounted in the box (8, 8′) for the relative rotating movement.

5. A hinge as claimed in claim 4, in which the receiving part (20, 20′, 220) exhibits opposing side walls (26, 27) which define an interjacent channel (25) for the hinge leaf (7, 207), the outer surfaces of which side walls converge in a direction outwards from the axis of rotation of the receiving part.

6. A hinge in accordance with claim 1, in which the holding box (8, 8′) is capable of moving adjustment relative to the receiving part (20, 20′) in a direction parallel to the axis (A) of the hinge, in order to permit vertical adjustment of the door (1).

7. A hinge as claimed in claim 5, with a vertical adjustment device in the form of an eccentric element (44) capable of actuation from outside, and rotatably mounted in the box (8) perpendicularly to the axis (A) of the hinge, which eccentric element engages with a portion (21a) of the receiving part (20).

8. A hinge as claimed in claim 6, with a vertical adjustment device comprising a nut element (100) rotatably mounted in the box (8′), capable of actuation from the outside, and locked in the axial direction relative to the box in engagement with a threaded journal (110), which is supported against the hinge leaf (7), in conjunction with which, when the nut element is rotated on the journal, the vertical movement of the element is transferred to the box.

9. A hinge as claimed in claim 8, in which the journal (110) is capable of movement relative to the receiving part (20′) in a direction parallel to the axis (A) of the hinge.

10. A hinge as claimed in claim 8, in which the journal (110) exhibits a flange (113) supported against the hinge leaf (7), which flange is accommodated and guided in a channel (111) provided for that purpose in the receiving part (20′).

11. A hinge as claimed in claim 10, in which the engagement of the flange (113) with the hinge leaf (7) is such that, when vertical adjustment of the door (1) in an upwards direction takes place through the actuation of an upper hinge nut element, a lower flanged hinge journal (110) accompanies the movement imparted to the door.

12. A hinge as claimed in claim 1, in which the hinge leaf (207) is movably adjustable relative to the frame part (204) in a direction parallel to the axis of the hinge in order to permit the vertical adjustment of the door.

13. A hinge as claimed in claim 12, in which the frame part (204) comprises a vertical adjustment device (270) that is capable of axial displacement in a frame knuckle (210b), by means of interacting threads, and a hinge pin (206) that is capable of displacement by the vertical adjustment device in an axial direction together with means (260) for transferring an axial movement imparted to the hinge pin to the hinge leaf (207).

14. A hinge as claimed in claim 1 in which the receiving part (20,20′, 220) exhibits a laterally projecting and preferably closable sleeve part (35) which accommodates the hinge leaf (7,207) locking, spring-actuated snap-in element (39,239), for the detachable securing of the leaf (7) in the receiving part (20, 20′).

15. A hinge as claimed in claim 14, in which the holding box (8, 8′) exhibits a corresponding, laterally projecting sleeve part (43) of larger dimensions in order to permit relative movement between the sleeve parts (35,43) of the receiving part (20, 20′, 220) and of the box (8, 8′).
